(19) United States
(12) Patent Application Publication
(10) Pub. No.: US 2024/0200950 A1
(43) Pub. Date: Jun. 20, 2024

(54) LOCATION NOTIFICATION SYSTEM, MOBILE, AND LOCATION NOTIFICATION METHOD

(71) Applicant: NIPPON TELEGRAPH AND TELEPHONE CORPORATION, Tokyo (JP)

(72) Inventors: Kazutaka HARA, Musashino-shi, Tokyo (JP); Ryo IGARASHI, Musashino-shi, Tokyo (JP); Junichi KANI, Musashino-shi, Tokyo (JP); Naotaka SHIBATA, Musashino-shi, Tokyo (JP); Takeshi IMAI, Musashino-shi, Tokyo (JP)

(73) Assignee: NIPPON TELEGRAPH AND TELEPHONE CORPORATION, Tokyo (JP)

(21) Appl. No.: 18/287,979

(22) PCT Filed: May 20, 2021
(86) PCT No.: PCT/JP2021/019110

§ 371 Date: Oct. 23, 2023

(51) Int. Cl. G01C 21/20; H04B 10/116

(52) U.S. Cl. CPC G01C 21/206; H04B 10/116

(57) ABSTRACT

An aspect of the present invention is a moving body that moves along a rail, the moving body including: a light emission unit; a movement control unit that controls the moving body so as to move on the rail at a predetermined speed; a measurement unit that measures a movement time of moving from a predetermined position on the rail; and a transmission unit that transmits a signal indicating position information corresponding to the movement time measured by the measurement unit by using the light emission unit.

### TECHNICAL FIELD

The present invention relates to technologies of a position notification system, a moving body, and a position notification method.

### BACKGROUND ART

Development of an outdoor position estimation technology using a global positioning system (GPS) allows us to know our own outdoor position. In the GPS, a distance between a user and a GPS satellite is measured, and a position of the user is estimated by three-point positioning. With the spread of navigation services using GPS, we can get to a destination without hesitation even in unknown areas.

On the other hand, an indoor positioning technology for achieving navigation in buildings is attracting attention in the future, and the global market size is expected to be about 17 billion USD by 2025 and the annual average growth rate is expected to be 22.5%.

Various methods for achieving indoor navigation have been proposed so far. For example, in a scheme based on a radio frequency (RF) signal using a beacon, Wi-Fi (registered trademark), or the like, a distance between terminals is measured from intensity of a signal received by a user terminal, and a user position can be specified by three-point positioning. Since this method uses electromagnetic waves, it can cover a wide range, but there is a concern that the accuracy is reduced due to the influence of interference in a complicated structure.

In the method by the pedestrian dead reckoning, the absolute position and direction when the user enters the building are measured using a sensor or the like of the user terminal, and the relative position from the position is tracked by a gyro sensor or the like to estimate the position of the user. This method does not require active device to be installed in a building, and the system can be introduced at low cost. However, as the distance to be estimated increases, errors between the estimated position and the actual position are accumulated, and there is a concern that the accuracy decreases.

For the background described above and the spread of indoor navigation, it is important to achieve sufficient accuracy while suppressing cost. As one of methods for achieving this, in recent years, a position estimation technology using visible light communication using LED lighting has been studied.

This is because, by simply attaching LED lighting for visible light communication, the LED lighting also functions as a communication infrastructure while maintaining the function of illumination, there is no need to attach equipment or secure a place for communication, and the LED itself is inexpensive.

As an example of indoor navigation using visible light, there is an indoor positioning system (IPS) disclosed in Non Patent Literature 1. This is a method in which a unique blinking pattern such as (1, 0, 0) or (1, 0, 1) is received by a smartphone camera for each LED lighting installed on the ceiling, and the position of the user is measured from position information of the LED lighting.

By installing a dedicated application in a user terminal and changing conventional lighting to LED lighting corresponding to the indoor positioning system, the lighting can be used as lighting and can also be used as a communication device for position measurement, and there is an advantage that highly accurate position information can be provided without introducing dedicated equipment even indoors where GPS signals do not reach.

FIG. 12 is a diagram illustrating a configuration example of an indoor navigation system using visible light. 14 pieces of LED lighting from #1 to #14 are installed on the ceiling to illuminate an indoor area, and an ID is transmitted from each LED lighting. For example, the ID of the LED lighting of #1 is “1000”, and the ID of the LED lighting of #2 is “1100”.

The user terminal (for example, a smartphone) receives the ID transmitted from each LED lighting by using the mounted illuminance sensor or camera. Since the ID and the LED lighting are associated on a one-to-one basis, the ID received from the terminal has the same meaning as the position of the LED lighting, and the position of the terminal can be grasped from a table in which the position and the ID of the LED lighting prepared by the dedicated application or the like are associated with each other.

### CITATION LIST

### Non Patent Literature

Non Patent Literature 1: “Indoor positioning system” using visible light communication, Internet (URL:https://www.signify.com/ja-jp/our-company/news/press-release-archive/2017/20170221-philips-lighting-introduces-advanced-connected-lighting-solutions)

### SUMMARY OF INVENTION

### Technical Problem

However, visible light is not diffracted or transmitted unlike radio waves, and has strong straightness. Therefore, in order to grasp the position using visible light, it is necessary to change all lighting devices to LED lighting (for example, LED lighting including a driver circuit for modulating ID and the like) compatible with the indoor positioning system, which may lead to an increase in cost from the viewpoint of replacement from conventional lighting, labor of installation work, and the number of lighting devices to be installed. As described above, the related art has a problem that it is difficult to economically construct a system for notifying a position.

In view of the above circumstances, an object of the present invention is to provide a technology capable of economically constructing a system for notifying a position.

### Solution to Problem

An aspect of the present invention is a moving body that moves along a rail, the moving body including: a light emission unit; a movement control unit that controls the moving body so as to move on the rail at a predetermined speed; a measurement unit that measures a movement time of moving from a predetermined position on the rail; and a transmission unit that transmits a signal indicating position information corresponding to the movement time measured by the measurement unit by using the light emission unit.

An aspect of the present invention is a control method of a moving body that moves along a rail and includes a light emission unit, the control method including a movement control step of controlling the moving body so as to move on the rail at a predetermined speed; a measurement step of measuring a movement time of moving from a predetermined position on the rail; and a transmission step of transmitting a signal indicating position information corresponding to the movement time measured in the measurement step by using the light emission unit.

An aspect of the present invention is a position notification system including a moving body and a rail along which the moving body moves, the position notification system including: a light emission unit; a movement control unit that controls the moving body so as to move on the rail at a predetermined speed; a measurement unit that measures a movement time of moving from a predetermined position on the rail; and a transmission unit that transmits a signal indicating position information corresponding to the movement time measured by the measurement unit by using the light emission unit.

### Advantageous Effects of Invention

According to the present invention, a system for notifying a position can be constructed economically.

### BRIEF DESCRIPTION OF DRAWINGS

FIG. 1 is a diagram illustrating a configuration example of a position notification system 1 according to a first embodiment.

FIG. 2 is a functional block diagram illustrating a functional configuration of a moving body 10.

FIG. 3 is a diagram illustrating a specific example of an area ID database.

FIG. 4 is a diagram illustrating current position information.

FIG. 5 is a diagram for specifically explaining movement of the moving body 10.

FIG. 6 is a flowchart illustrating a flow of processing of the moving body 10 in the first embodiment.

FIG. 7 is a diagram illustrating the position notification system 1 in which a marker 160 is provided on a floor.

FIG. 8 is a functional block diagram illustrating a functional configuration of a moving body 10 in a second embodiment.

FIG. 9 is a functional block diagram illustrating a functional configuration of a moving body 10 in a third embodiment.

FIG. 10 is a diagram illustrating a change mode of an optical axis.

FIG. 11 is a diagram illustrating an example of an irradiation range.

FIG. 12 is a diagram illustrating a configuration example of an indoor navigation system using visible light.

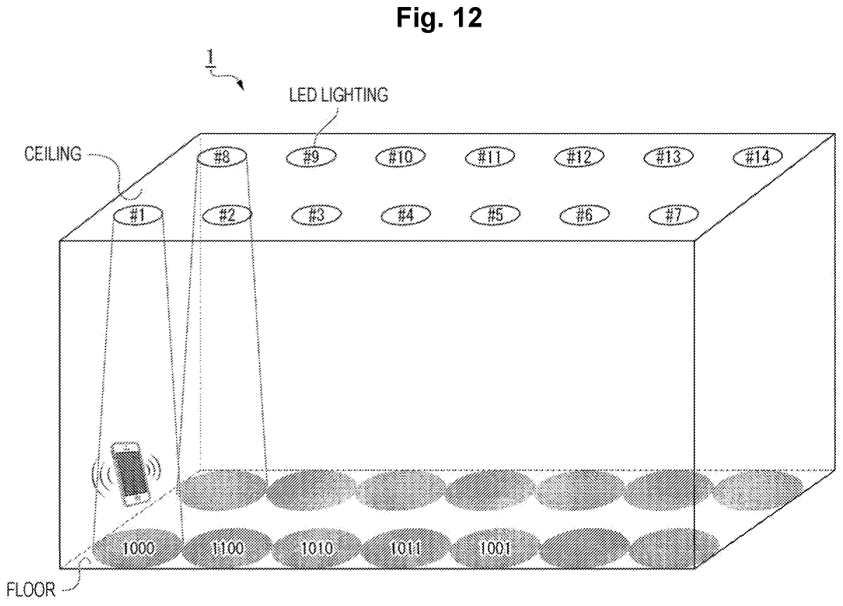

### DESCRIPTION OF EMBODIMENTS

Embodiments of the present invention will be described in detail with reference to the drawings.

### First Embodiment

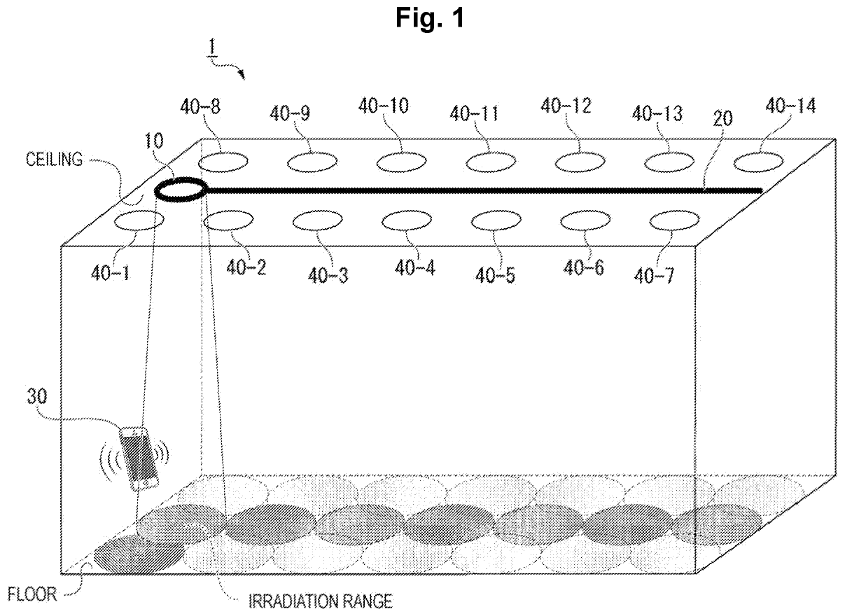

FIG. 1 is a diagram illustrating a configuration example of a position notification system 1 according to a first embodiment. The position notification system 1 includes a moving body 10 and a rail 20. The moving body 10 and the rail 20 are provided on a ceiling. The moving body 10 moves along the rail 20. FIG. 1 further illustrates lighting 40-1, . . . , 40-14. The lighting 40-1, . . . , 40-14 is normal lighting that does not transmit an ID or the like, and is, for example, an LED or incandescent bulb.

The moving body 10 moves at a constant speed (v (m/s)) except when it starts moving and when it decelerates and stops during movement. Since the time from the start of the movement to the speed v and the time from the deceleration to the stop are short, it is assumed that the moving body 10 is stopped or is moving at the speed v.

The moving body 10 includes a light emission unit to be described later. The moving body 10 transmits the position information by using the light emission unit. The mobile terminal 30 receives the transmitted position information and acquires the position information of the mobile terminal 30. The acquired position information is displayed on, for example, a screen, and the user of the mobile terminal 30 can recognize the position.

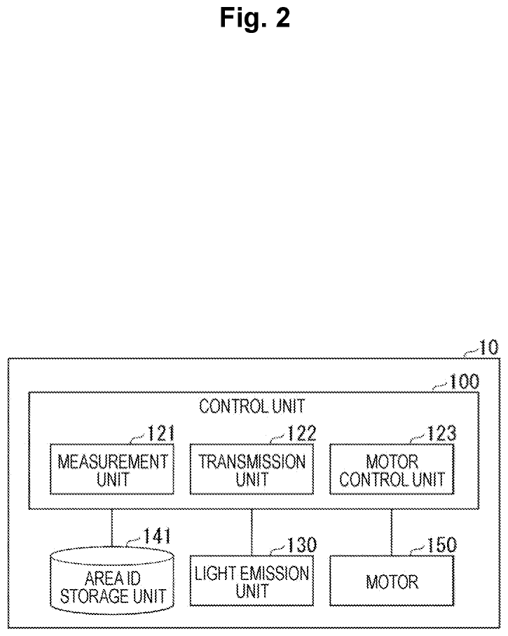

FIG. 2 is a functional block diagram illustrating a functional configuration of the moving body 10. The moving body 10 includes a central processing unit (CPU), a memory, an auxiliary storage device, and the like connected via a bus, and functions as a device including a control unit 100, an area ID storage unit 141, a light emission unit 130, and a motor 150 by executing a control program.

Note that all or some functions of the control unit 100 and the area ID storage unit 141 may be implemented using hardware such as an application specific integrated circuit (ASIC), a programmable logic device (PLD), or a field programmable gate array (FPGA). The control program may be recorded on a computer-readable recording medium. Examples of the computer-readable recording medium include a portable medium such as a flexible disk, a magneto-optical disk, a ROM, a CD-ROM, or a semiconductor storage device (for example, a solid-state drive (SSD)), and a storage device such as a hard disk built in a computer system. The control program may be transmitted via an electrical communication line.

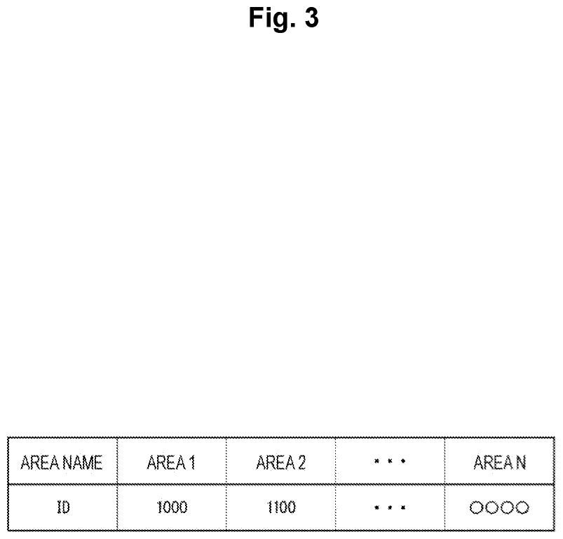

The area ID storage unit 141 is configured using a storage device such as a semiconductor storage device, a magnetic hard disk device, or the like. The area ID storage unit 141 stores an area ID database. FIG. 3 is a diagram illustrating a specific example of an area ID database. The area database includes an area name and an ID. The area name is a name of an area. In FIG. 3, areas 1 to N are illustrated as examples of area names. The ID is an example of the position information. The ID is uniquely provided for each area name.

The light emission unit 130 is LED lighting. The light emission unit 130 irradiates a floor with light. The light emission unit 130 can transmit a signal to the mobile terminal 30 according to a blinking pattern corresponding to the ID. The motor 150 is a drive unit for the moving body 10 to move on the rail 20. The motor 150 transmits power to wheels for moving on the rail 20. The motor 150 is driven under the control of the control unit 100.

The control unit 100 in FIG. 2 controls the operation of each unit of the moving body 10. The control unit 100 is implemented by, for example, a device including a processor such as a CPU and a RAM. The control unit 100 functions as a measurement unit 121, a transmission unit 122, and a motor control unit 123 by executing a control program.

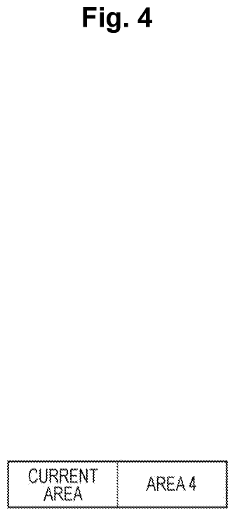

The measurement unit 121 measures a movement time in which the moving body 10 moves on the rail 20. The transmission unit 122 transmits a signal indicating position information corresponding to the measured movement time using by the light emission unit 130. The transmission unit 122 stores current position information indicating an area where the moving body 10 is currently located in a storage device such as a RAM. FIG. 4 is a diagram illustrating current position information. The current position information indicates an area name of an area recognized as the current position by the moving body 10. In the case of FIG. 4, the current position information indicates an area 4. The motor control unit 123 is an example of the movement control unit. The motor control unit 123 controls the motor 150 to control the moving body 10 so as to move on the rail 20 at a predetermined speed v.

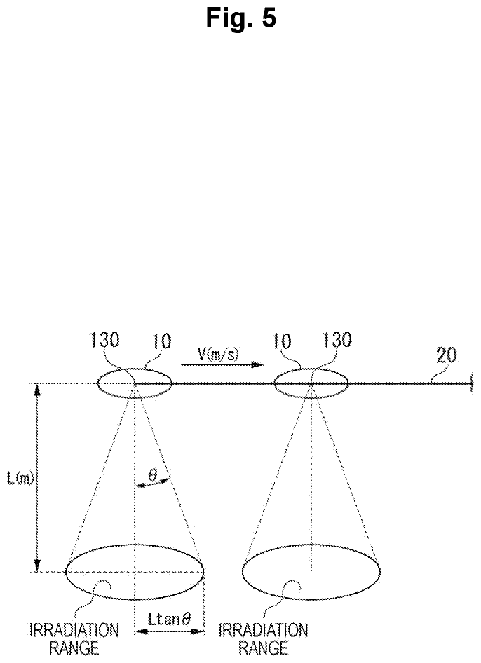

FIG. 5 is a diagram for specifically explaining movement of the moving body 10. A distance from the light emission unit 130 of the moving body 10 to the floor is L (m). When a radiation angle of the light emission unit 130 is 20, the radius of the irradiation range is L tan θ. Therefore, when the irradiation ranges are arranged along the rail 20 so as not to overlap each other, as illustrated in FIG. 1, an aspect in which circles are tied in a row is obtained. In a case where this circle is set as one area and the ID is controlled to be switched for each area, the ID is switched every time the moving body 10 moves by the diameter 2L tan θ of the irradiation range. That is, when the movement time of the moving body 10 is T (=(2L tan θ)/v) as the diameter of the irradiation range, the ID to be transmitted is switched every time the movement time of an integral multiple of the movement time T of the moving body 10 arrives. Adjustment may be performed to cover a wider area by providing a diffuser for diffusing light in the light emission unit 130.

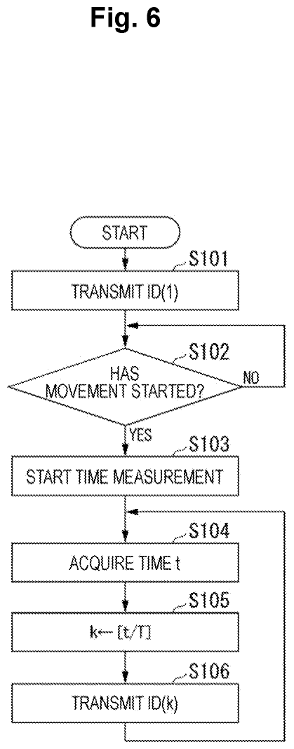

FIG. 6 is a flowchart illustrating a flow of processing of the moving body 10 in the first embodiment. In the flowchart of FIG. 6, it is assumed that the moving body 10 is initially located at an initial position (for example, the left end of the rail 20). ID (k) in the flowchart represents the area ID database illustrated in FIG. 3 as an array. Specifically, k indicates an area name (area k), and ID (k) indicates an ID in the area k. k has an initial position of 1, and increases by 1 each time the area changes by moving to the right. T is a time during which the moving body 10 moves through the diameter of the irradiation range described above.

The transmission unit 122 transmits a signal indicating ID (1) at the initial position by using the light emission unit 130 (step S101). When the moving body 10 starts moving (step S102: YES), the measurement unit 121 starts time measurement (step S103). The transmission unit 122 acquires the measured time t (step S104). The transmission unit 122 substitutes [t/T] for k by using the acquired time t (step S105). Here, [•] is a Gaussian symbol. The transmission unit 122 transmits a signal indicating ID (k) by using the light emission unit 130 (step S106), and the process returns to step S104.

In step S105 described above, the position information to be transmitted is switched every time the movement time that is an integral multiple of the time during which the moving body 10 moves in the diameter of the irradiation range arrives. The timing of returning from step S106 to step S104 may be a timing after a lapse of a time that causes no operational problem. In a case where the moving direction is inverted such as leftward, the measurement unit 121 subtracts the time measured during the inversion from the time t at the timing of the inversion. For example, in a case where the time t at the timing of inversion is 10 seconds and the time measured during inversion is 3 seconds, the time t is set to 7 seconds.

According to the first embodiment described above, by moving the lighting capable of transmitting the ID, the number of pieces of lighting capable of transmitting the ID can be reduced as compared with the prior art. Therefore, even in an indoor area where a GPS signal does not reach, a position notification system can be constructed economically.

### Second Embodiment

In the following description, the same components as those of the first embodiment are denoted by the same reference numerals, and the description may be omitted. It is conceivable that the moving speed does not become a constant speed due to aging deterioration of the moving body 10 and the rail 20, or the moving speed becomes a speed other than v even if the moving speed is a constant speed. In this case, the ID to be transmitted may be erroneously the ID of another area.

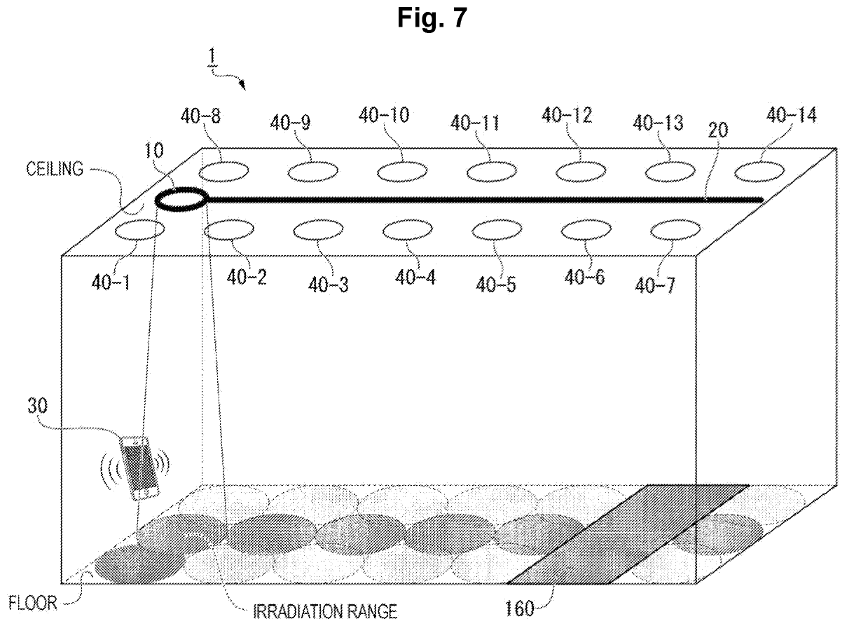

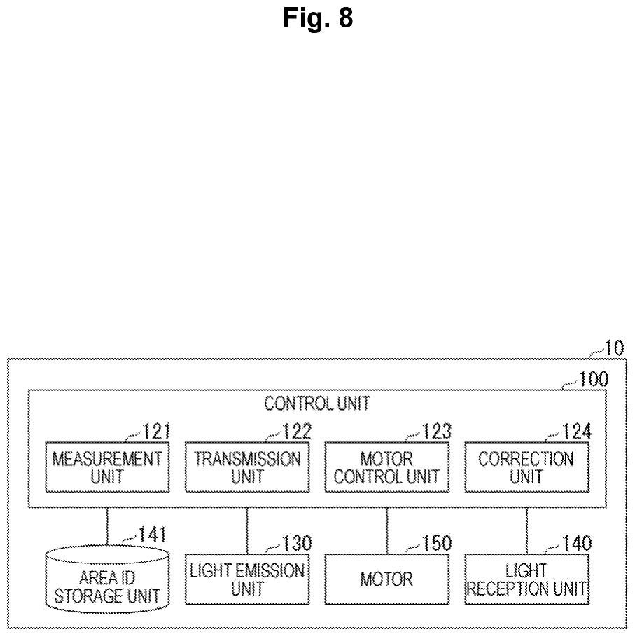

Therefore, in the second embodiment, a marker that reflects light emitted by the light emission unit 130 is provided on the floor. FIG. 7 is a diagram illustrating the position notification system 1 in which a marker 160 is provided on a floor. FIG. 8 is a functional block diagram illustrating a functional configuration of a moving body 10 in the second embodiment. In the second embodiment, a correction unit 124 and a light reception unit 140 are provided in addition to the configuration of the first embodiment.

The light reception unit 140 receives reflected light in which light emitted from the light emission unit 130 is reflected by the marker 160. The light reception unit 140 includes, for example, an illuminance sensor, a CCD camera, a photo diode (PD), and the like. The correction unit 124 corrects the position information according to the reflected light received by the light reception unit 140. For example, in a case where the light reception unit 140 receives the reflected light from the marker 160, the correction unit 124 corrects the time t. Specifically, it is assumed that the marker 160 is provided at a position that takes t1 seconds in a case where the moving body 10 moves from the left end at the speed v. In this case, when the light reception unit 140 receives the reflected light from the marker 160, the correction unit 124 corrects the time t measured by the measurement unit 121 to t1. As a result, the ID ([t/T]) is corrected to the ID ([t1/T]). The measurement unit 121 resumes the measurement using t1 after correction to t1.

As similar to this, in a case where a plurality of markers is provided, the markers are provided so as to have different reflected light for each marker. Then, the time required when the moving body 10 moves from the left end at the speed v is stored for each marker. The correction unit 124 corrects the ID by correcting the time t to the time corresponding to the reflected light.

As a result, even if the ID to be transmitted becomes the ID of another area due to aging or the like, it is possible to correct the ID to a correct ID.

### Third Embodiment

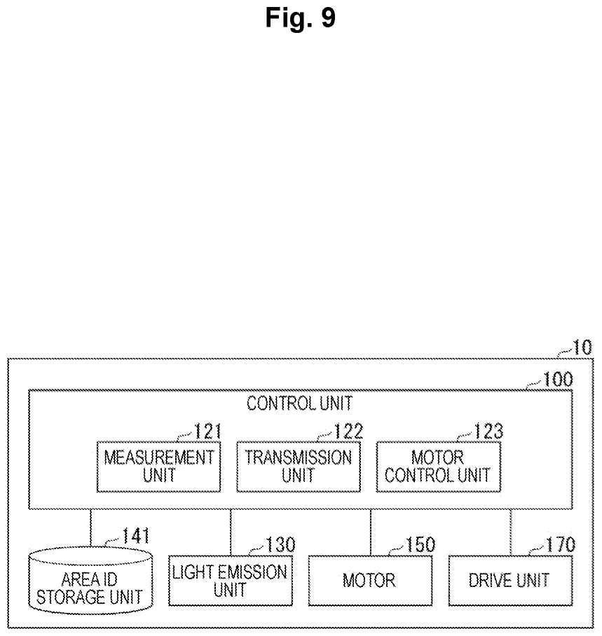

In the following description, the same components as those of the first embodiment are denoted by the same reference numerals, and the description may be omitted. FIG. 9 is a functional block diagram illustrating a functional configuration of a moving body 10 in a third embodiment. In the third embodiment, a drive unit 170 is provided in addition to the configuration of the first embodiment.

The drive unit 170 drives the light emission unit 130 in a direction perpendicular to the moving direction of the moving body 10 within a range in which an angle formed by an optical axis of light emitted by the light emission unit 130 and an optical axis serving as a reference is a predetermined angle or less. The irradiation range of the light emission unit 130 is changed by the drive unit 170.

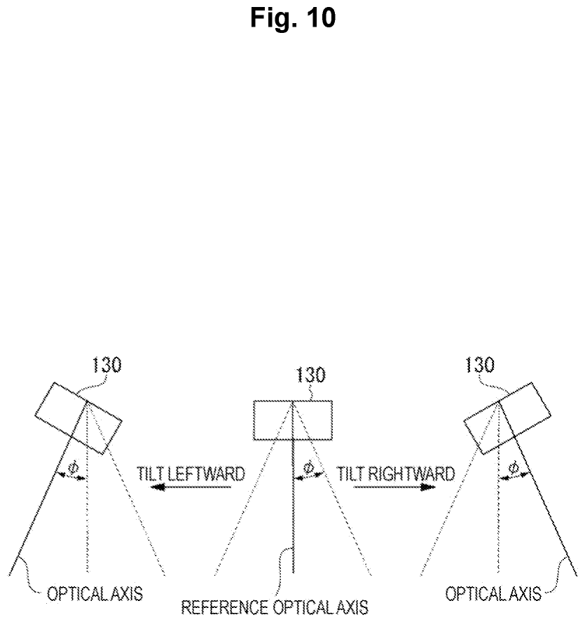

FIG. 10 is a diagram illustrating a change mode of an optical axis. In FIG. 10, the direction from the back to the front of the drawing is the moving direction of the moving body 10. The reference optical axis serving as a reference is an optical axis serving as a perpendicular line dropped from the rail 20 to the floor. That is, it is an optical axis directed straight downward. The drive unit 170 operates the light emission unit 130 like a pendulum to the left and right within a range where an angle formed with the optical axis serving as a reference is a predetermined angle ϕ.

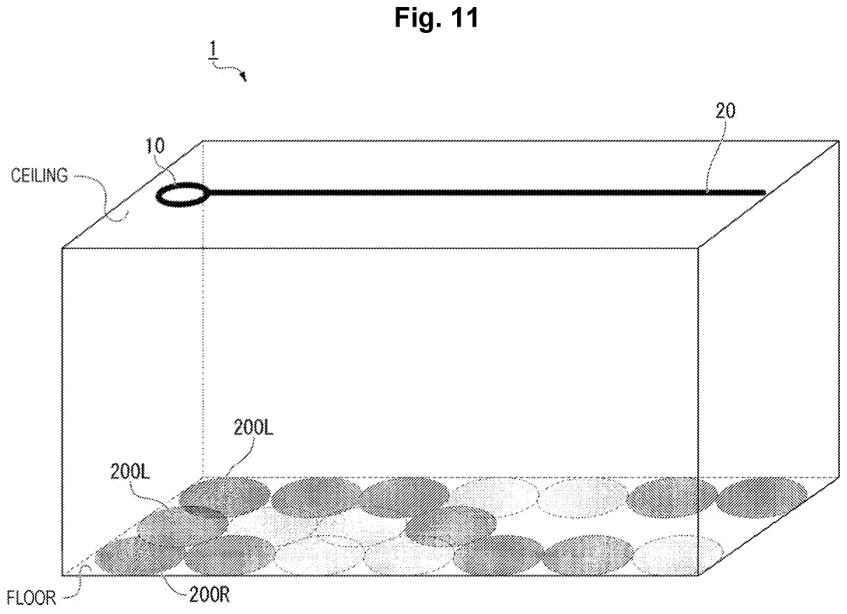

FIG. 11 is a diagram illustrating an example of an irradiation range. As the irradiation range, in addition to an irradiation range 200 in the case of not operating, irradiation ranges 200R and 200L are included by operating the light emission units 130 on the left and right.

As a result, since the irradiation area is wider than that of the first embodiment, a range in which the mobile terminal 30 can receive light can be widened. That is, the range can be widened without changing the number of light emission units. Accordingly, the number of pieces of lighting capable of transmitting the ID can be reduced as compared with the prior art. Therefore, even in an indoor area where a GPS signal does not reach, a position notification system can be constructed economically.

The transmission unit 122 may switch the position information to be transmitted according to the angle formed by the optical axis of the light emitted by the light emission unit 130 and the optical axis serving as the reference. For example, the ID transmitted when the angle θ formed by the optical axis of the light emitted by the light emission unit 130 and the optical axis serving as the reference is within the range of 0 to τ (τ<ϕ) and the ID transmitted when the angle θ formed is within the range of τ to ϕ may be different from each other. This makes it possible to enhance the position resolution.

For example, the second embodiment and the third embodiment can be combined. In this case, in the third embodiment, a marker is provided on the floor, and a light reception unit and a correction unit are further provided on the moving body 10. When the light reception unit receives the reflected light from the marker, the correction unit corrects the time t regardless of the direction of the optical axis. As a result, also in the third embodiment, even if the ID to be transmitted becomes the ID of another area due to aging or the like, it is possible to correct the ID to a correct ID.

In the embodiments described above, even when the mobile terminal 30 is in, for example, an area 2, there is a possibility that the ID corresponding to the area 1 is received. In order to avoid this, a lens capable of narrowing the beam spot within the irradiation range corresponding to the transmitting ID is used.

In a case where the overall length of the rail is relatively long, a plurality of moving bodies may be provided, or a plurality of rails may be provided, and each of the moving bodies may be provided. Since the position resolution depends on the speed of the moving body 10, the position resolution can be set, and the speed of the moving body may be controlled according to the set position resolution.

Although the moving body is provided on the ceiling, the moving body may be provided on a side surface such as a wall, a floor, or the like as long as the mobile terminal can receive light. The light emitted by the light emission unit is not limited to visible light as long as the light can be received by an illuminance sensor or a camera, and may be near-infrared light or the like. In the above embodiment, the information is transmitted using the blinking pattern, but instead of this, a color change or intensity of light may be used.

Although the embodiment of the present invention has been described in detail with reference to the drawings, specific configurations are not limited to the embodiment, and include designs and the like without departing from the scope of the invention.

### INDUSTRIAL APPLICABILITY

The present invention is applicable to a system that notifies a location indoors.

### REFERENCE SIGNS LIST

1 Position notification system
10 Moving body
20 Rail
30 Mobile terminal
40-1, 40-2, 40-3, 40-4, 40-5, 40-6, 40-7, 40-8, 40-9, 40-10, 40-11, 40-12, 40-13, 40-14 Lighting
100 Control unit
121 Measurement unit
122 Transmission unit
123 Motor control unit
124 Correction unit
130 Light emission unit
140 Light reception unit
141 Storage unit
150 Motor
160 Marker
170 Drive unit
200, 200L, 200R Irradiation range

1. A moving body that moves along a rail, the moving body comprising:
a light emission unit;
a movement control unit that controls the moving body so as to move on the rail at a predetermined speed;
a measurement unit that measures a movement time of moving from a predetermined position on the rail; and
a transmission unit that transmits a signal indicating position information corresponding to the movement time measured by the measurement unit by using the light emission unit.

2. The moving body according to claim 1, wherein the transmission unit switches the position information to be transmitted each time a movement time that is an integral multiple of a time during which the moving body moves by a length corresponding to a diameter of an irradiation range of the light emission unit arrives.

3. The moving body according to claim 1, further comprising: a light reception unit that receives reflected light that is light emitted by the light emission unit being reflected; and
a correction unit that corrects the position information according to the reflected light received by the light reception unit.

4. The moving body according to claim 1, further comprising a drive unit that drives the light emission unit in a direction perpendicular to a moving direction of the moving body within a range in which an angle formed by an optical axis of light emitted by the light emission unit and an optical axis serving as a reference is a predetermined angle or less, wherein the drive unit changes an irradiation range of the light emission unit.

5. The moving body according to claim 4, wherein the transmission unit switches the position information to be transmitted according to an angle formed by the optical axis of the light emitted by the light emission unit and the optical axis serving as the reference.

6. A control method of a moving body that moves along a rail and includes a light emission unit, the control method comprising:
a movement control step of controlling the moving body so as to move on the rail at a predetermined speed;
a measurement step of measuring a movement time of moving from a predetermined position on the rail; and
a transmission step of transmitting a signal indicating position information corresponding to the movement time measured in the measurement step by using the light emission unit.

7. A position notification system comprising a moving body and a rail along which the moving body moves, the position notification system further comprising:
a light emission unit;
a movement control unit that controls the moving body so as to move on the rail at a predetermined speed;
a measurement unit that measures a movement time of moving from a predetermined position on the rail; and
a transmission unit that transmits a signal indicating position information corresponding to the movement time measured by the measurement unit by using the light emission unit.
